(19) United States
(12) Patent Application Publication
(10) Pub. No.: US 2010/0028121 A1
(43) Pub. Date: Feb. 4, 2010

(54) System for Arranging and/or Storing Objects

(76) Inventors: Robert Lalesse, Zevenaar (NL); Robert Gerhard Elmar Vorwerk, Doetinchem (NL); Theodorus Robertus Maria Willemse, Veenendaal (NL)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/084,456

(22) PCT Filed: Nov. 1, 2006
(86) PCT No.: PCT/NL2006/000545

§ 371 Date: Jul. 6, 2009

(30) Foreign Application Priority Data
Nov. 1, 2005 (NL) 1030328

(51) Int. Cl. B65G 61/00

(52) U.S. Cl. 414/802; 198/570

(57) ABSTRACT

A system for arranging and/or storing objects, for instance for the purpose of forming stacking patterns, comprising: —at least two object group conveyors (10) which are configured for holding objects (P) in at least two respective object groups, while each object group conveyor (10) is drivable, in particular for moving an object group held by this conveyor (10); and—at least a first drive (20) for driving the at least two object group conveyors; wherein the first drive (2) can be brought in at least a first and second position for driving only the first or second object group conveyor (10), respectively.

The invention relates to a system for arranging and/or storing objects, for the purpose of, for instance, forming stacking patterns.

From practice, various systems are known for arranging and/or storing objects, for instance products, boxes or the like, in groups. The system can for instance operate in normal working environments such as storehouses and production buildings, and in cold stores, temperature controlled environments and/or other environments. The objects may be arranged for the purpose of preparing particular orders, deliveries and the like. The system can be used in, for instance, a goods distribution system, a ‘total-supply-chain’ of, for instance, a store-chain and the like. Arranging products can be desired for stacking the products, for instance in a manner as described in Dutch patent NL 1025826.

A drawback of known systems is that they are relatively complex, expensive and slow. The fact is that known systems are not very well capable of arranging and/or storing large amounts of objects, for instance boxes, in a short period of time, in particular when various objects differ from each other as regards, for instance, shape and/or dimension. Further, known systems are relatively maintenance prone.

The object of the present invention is an improvement of a system for arranging and/or storing objects. The invention contemplates in particular a system that can arrange and/or store objects in a relatively efficient manner and/or rapidly and with relatively inexpensive means.

To this end, the system according to the invention is characterized in that it is provided with:
at least two object group conveyors which are configured for holding objects in at least two respective object groups, while each object group conveyor is drivable, for, for instance, moving an object group held by this conveyor; and
at least a first drive for driving the at least two object groups conveyors;

wherein the first drive can be brought in at least a first and second position for driving only the first or only the second object group conveyor, respectively.

In this manner, for instance only one first drive can be utilized or a very small number of first drives, for driving a large number of different object group conveyors independently of each other.

During use, the first drive can simply be brought in a first position for driving only the first object group conveyor, and in a second position for driving only the second object group conveyor. When utilizing more than two object group conveyors, for instance ten or more, a proportional number of driving positions may be used, in which positions the first drive can service one of the object group conveyors. The various object group conveyors can form, for instance, a sorting buffer, for distributing objects over respective buffer channels.

Hence, the object group conveyors themselves are preferably not provided with a conveyor drive. As a result, the system can be designed to be relatively inexpensive and maintenance friendly, in particular when the system is provided with a very large number of object group conveyors, for instance when it is desired to prepare a very large number of object groups. Such a large number can comprise, for instance, at least 50, at least 100, or even at least 1000 object group conveyors, while, each time, each of these conveyors can be driven by only a very limited number of first drives (for instance only one), instead of by at least 50, 100 or 1000 separate drives, respectively.

These object group conveyors can be designed in different manners. Preferably, each object group conveyor is an endless conveyor, which is provided with, for instance, a conveyor belt.

At least several of the objects mentioned can have different shapes and/or dimensions and/or masses. With the present system, such objects can relatively rapidly and reliably be subdivided or sorted into desired groups. In addition, similar objects can be arranged and/or stored in groups by the system, for instance objects of similar dimensions, shapes and masses.

It is further advantageous when, during use, objects are positioned at a distance from each other on at least one object group conveyor, utilizing in particular a first drive mentioned. Mutual contact between the objects can thus be avoided. Furthermore, the objects can thus be held apart, be counted and/or be detected in a simple manner, by means of, for instance, simple optical sensors that can detect intermediate spaces between the objects.

In addition, it is advantageous when the system is designed for each time, during use, disposing the objects substantially centrally on object group conveyors, at least centrally relative to a lateral conveying direction. In this manner, the objects can be held stably by the object group conveyors, both at low and high conveying speeds of the respective conveyors.

In addition, it is advantageous if conveying surfaces, or object bearing surfaces, of the object group conveyors extend substantially in horizontal direction. As a result, mutual thrust between the objects can be avoided which is beneficial to the stability of the objects held on the object group conveyors, and counteracts or prevents damage of the objects.

According to a further elaboration of the invention, an object group is related to an object stack to be formed, and, in particular, to a horizontal stacking pattern of an object stack to be formed.

In a preferred embodiment, the first drive is movable between at least a first driving position for driving only the first object group conveyor, and a second driving position for driving only the second object group conveyor.

According to a further elaboration of the invention, the system is provided with a conveying mechanism for moving a first drive between the at least first and second driving position, while the conveying mechanism is provided with a movable drive carrier, which carrier is provided with this first drive.

The conveying mechanism can move a first drive in a relatively rapid and controlled manner between desired driving positions. In an advantageous elaboration, the conveying mechanism is provided to this end with, for instance, a guide for guiding the drive carrier between desired positions. The drive carrier can for instance comprise a trolley or the like, movable along and/or over guide rails.

In a preferred embodiment, the drive carrier is further provided with an object manipulator for manipulating the objects.

The manipulator can for instance be configured for manipulating objects present near the drive carrier. In this manner, in addition to carrying the first drive for operating the group conveyors, the drive carrier can also be configured for manipulating the objects themselves. In particular, the manipulator of the drive carrier can be designed for displacing in a desired direction objects having moved towards the drive carrier, in particular at a moment the drive carrier has brought a first drive in a desired driving position. The manipulator can for instance be intended for bringing objects, supplied via a supply conveyor, to an object group conveyor for, for instance, supplying the object to an object group associated with this group conveyor. Additionally, a manipulator may be intended for receiving objects from object group conveyors, and for, thereupon, discharging the objects.

In the case an object manipulator and a first drive are provided on the same movable drive carrier, it is particularly advantageous if the first drive and object manipulator are designed for cooperation, for moving objects between, on the one side, a supply and/or discharge conveyor and, on the other side, object group conveyors. Through such cooperation, objects can simply and rapidly be transferred to the various object group conveyors for forming groups, and/or be received therefrom, for instance after formation of groups.

It is further advantageous when a system for arranging and/or storing objects, for instance an above-cited system, is provided with:
at least two object group conveyors which are configured for holding objects in at least two respective object groups;
a supply and/or discharge conveyor for carrying objects to be arranged along object receiving parts and/or object dispensing parts of the object group conveyors; and
an object manipulator for moving objects between the supply conveyor and the object group conveyors,

wherein the object manipulator is movable between at least a first moving position for moving objects only between, on the one side, the first object group conveyor and, on the other side, the supply and/or discharge conveyor, and a second moving position for moving objects only between, on the one side, the second object group conveyor and, on the other side, the supply and/or discharge conveyor.

Moving the object group manipulator can be carried out in a favourable manner with, for instance, a conveying mechanism, while the conveying mechanism is preferably provided with a carrier that carries the manipulator, and more preferably, also for instance a first drive, as with an above-mentioned conveying mechanism.

An aspect of the invention further provides a system, for instance an above-mentioned system for arranging and/or storing objects, provided with a sorting device, while the sorting device is designed for bringing an object row in a predetermined order, the sorting device being provided with:
a first track for receiving an object row, while the first track comprises, in particular, a first endless conveyor;
at least a second track extending along the first track, which second track comprises, in particular, a second endless conveyor, and
one or more object movers for moving objects from a row part present on the first track, and placing them in a predetermined order on a second track, while the first track is provided, in particular, with these object movers.

In addition, an aspect of the invention relates to a method for arranging objects in substantially horizontal stacking patterns. Here, it is advantageous when the method comprises a first sorting step wherein the objects are divided into groups, which groups correspond to the stacking patterns to be formed, while, during a second sorting step, the groups are brought into rows with an order suitable for stacking, while in particular, at least several of these objects have different shapes and/or dimensions and/or masses. In this manner, the objects can rapidly be brought into an order suitable for stacking. Preferably, the stacking patterns substantially comprise horizontal stacking patterns. The above-mentioned system can for instance be utilized for distributing the groups at the first sorting step over various object group conveyors.

Further elaborations of the invention are described in the subclaims. Presently, the invention will be clarified on the basis of an exemplary embodiment and the drawing. In the drawing:

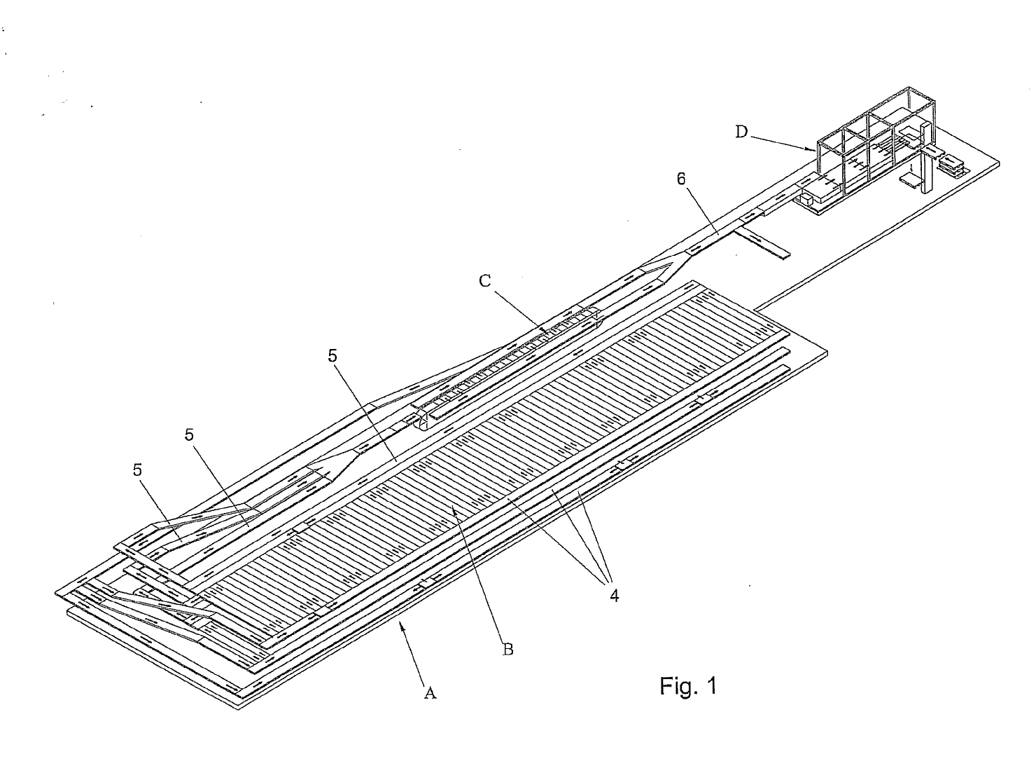

FIG. 1 shows a perspective top plan view of an exemplary embodiment of an object arranging and stacking system;

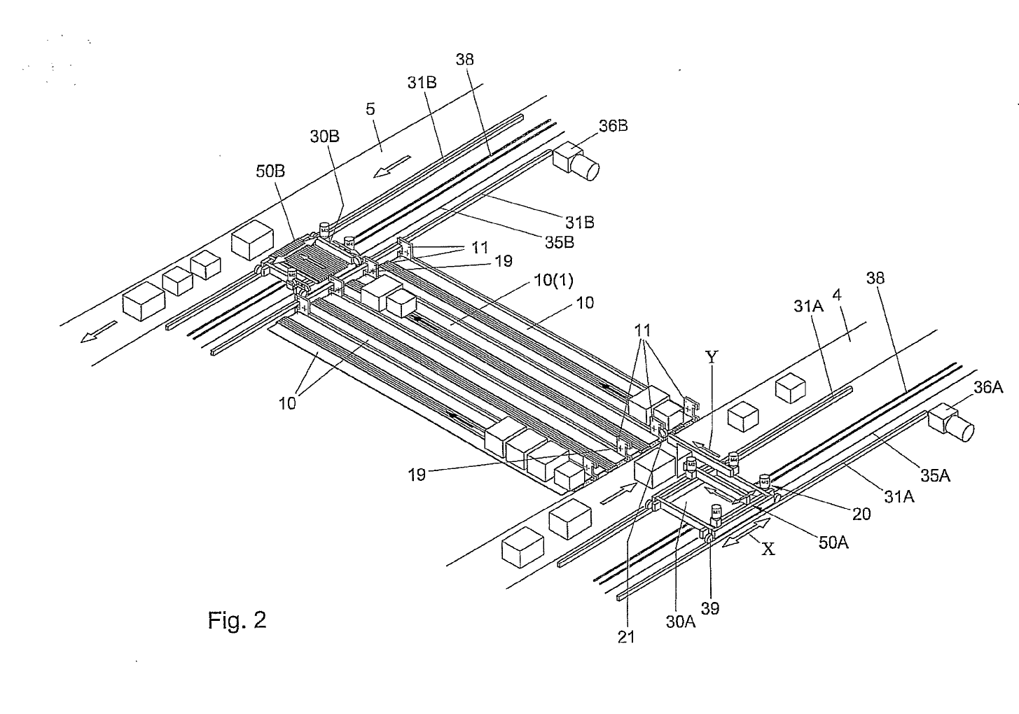

FIG. 2 shows a first part of the system represented in FIG. 1, comprising a presorting device;

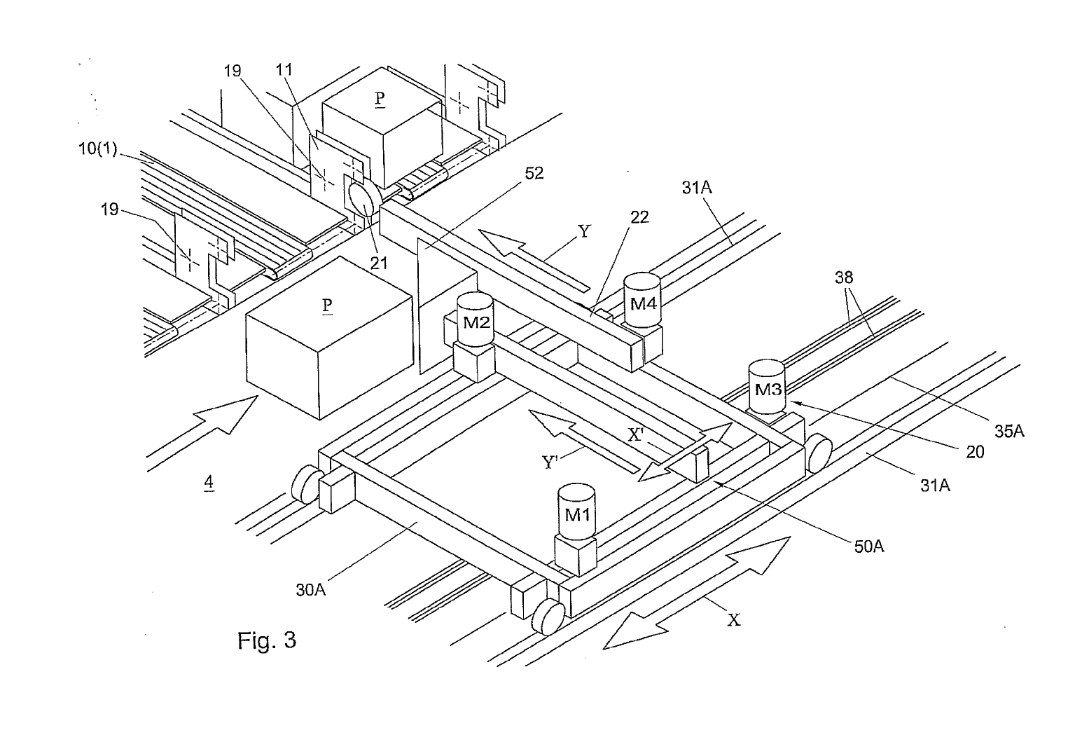

FIG. 3 shows a first detail of FIG. 2, wherein a first drive carrier is represented;

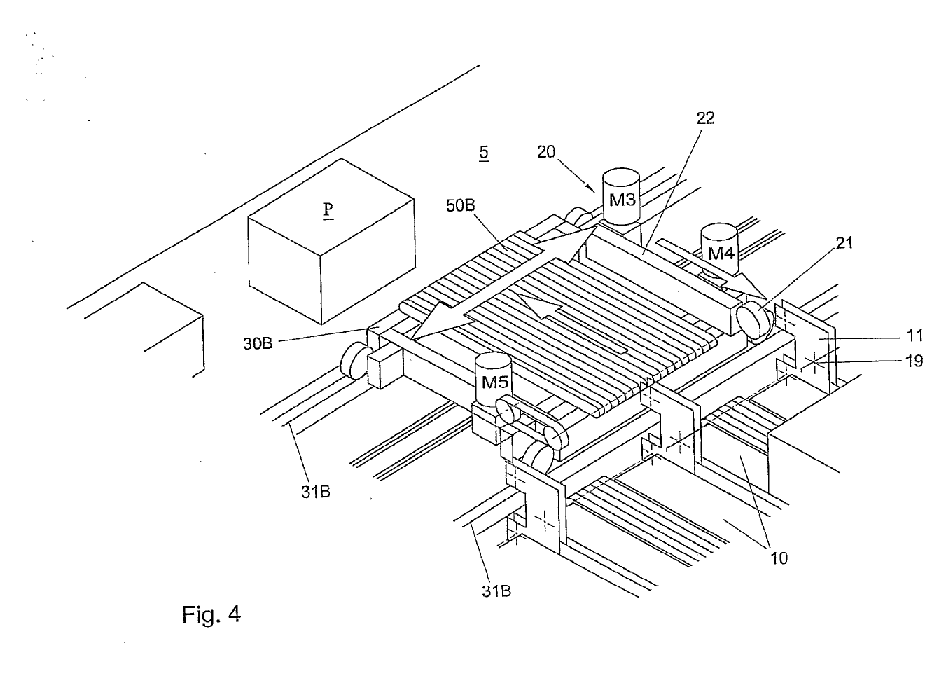

FIG. 4 shows a second detail of FIG. 2, wherein a second drive carrier is represented;

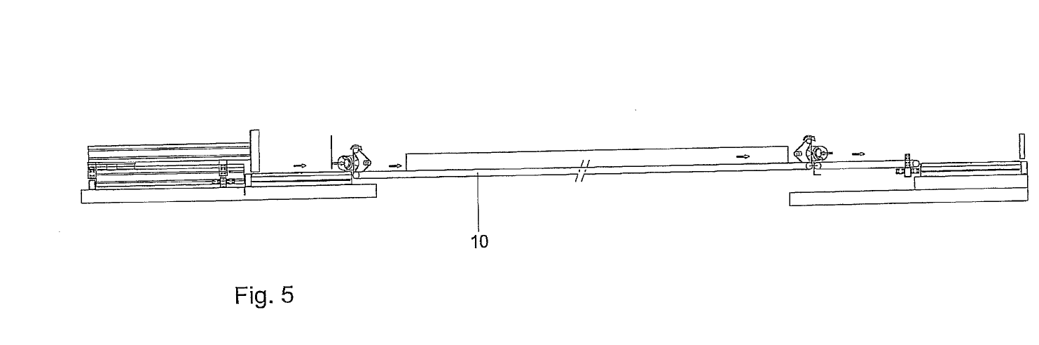

FIG. 5 shows a side view of the detail represented in FIG. 2, wherein a buffer channel is represented;

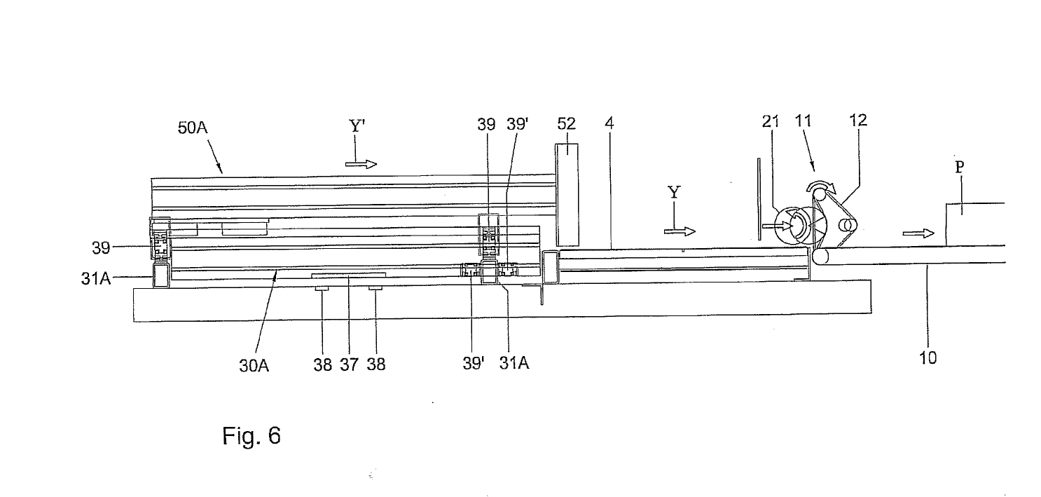

FIG. 6 shows an upstream part of the side view represented in FIG. 5;

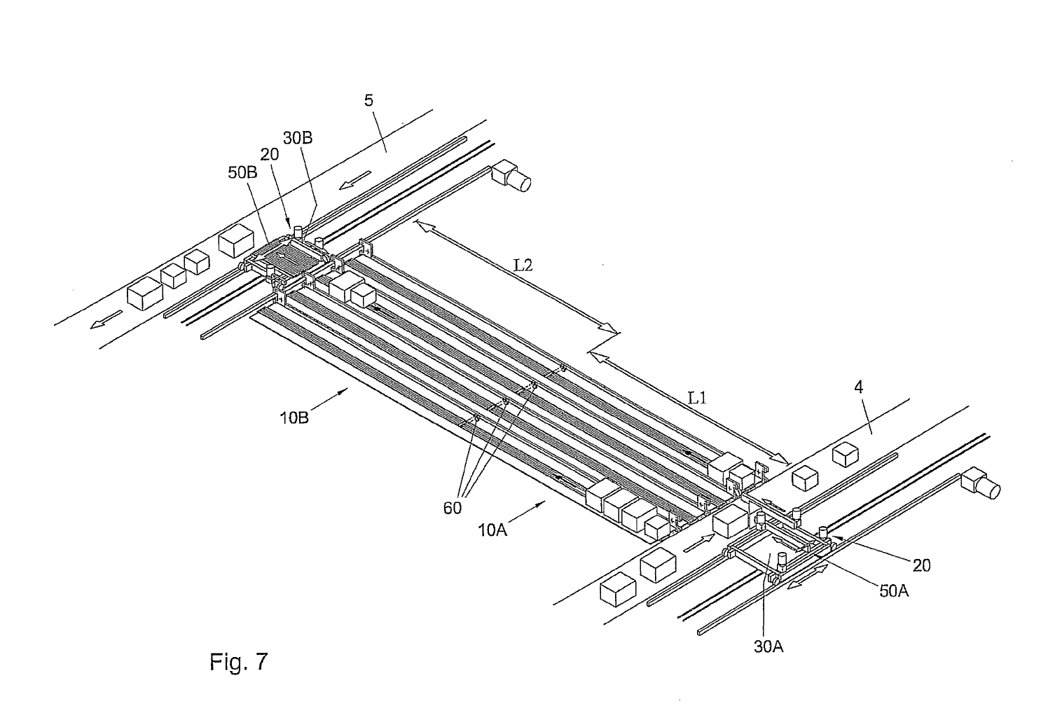

FIG. 7 shows a similar drawing as FIG. 2 of a first alternative design;

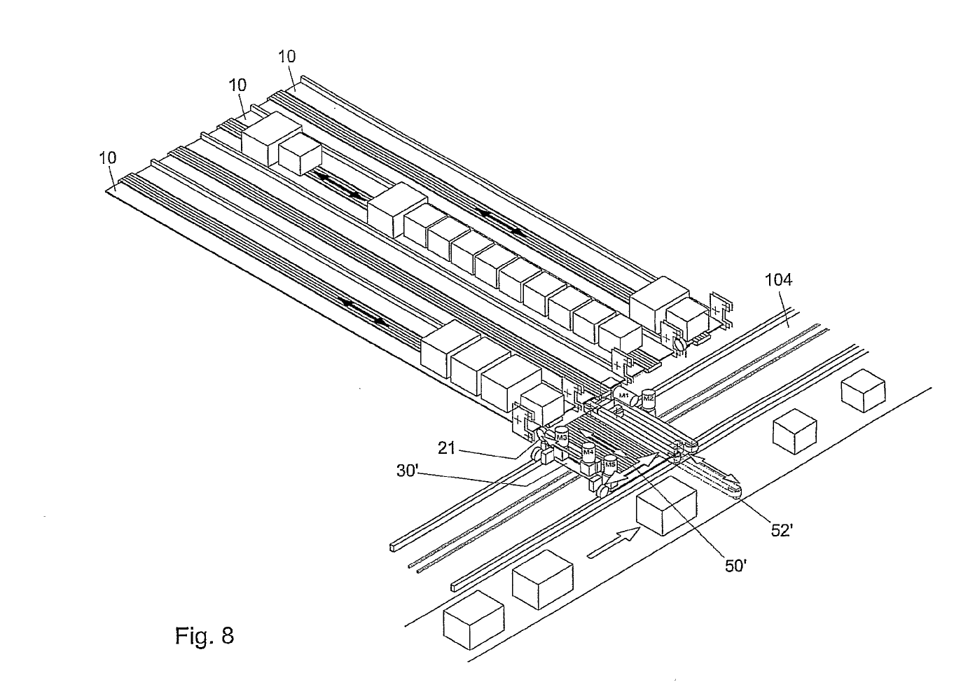

FIG. 8 shows a similar drawing as FIG. 2 of a second alternative design;

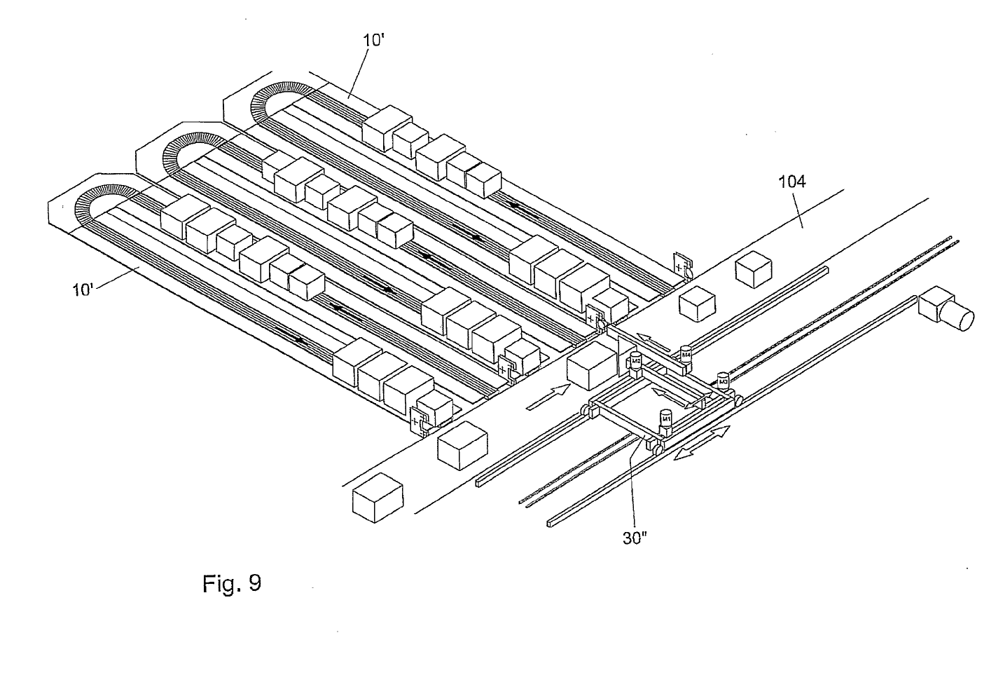

FIG. 9 shows a similar drawing as FIG. 2 of a third alternative design;

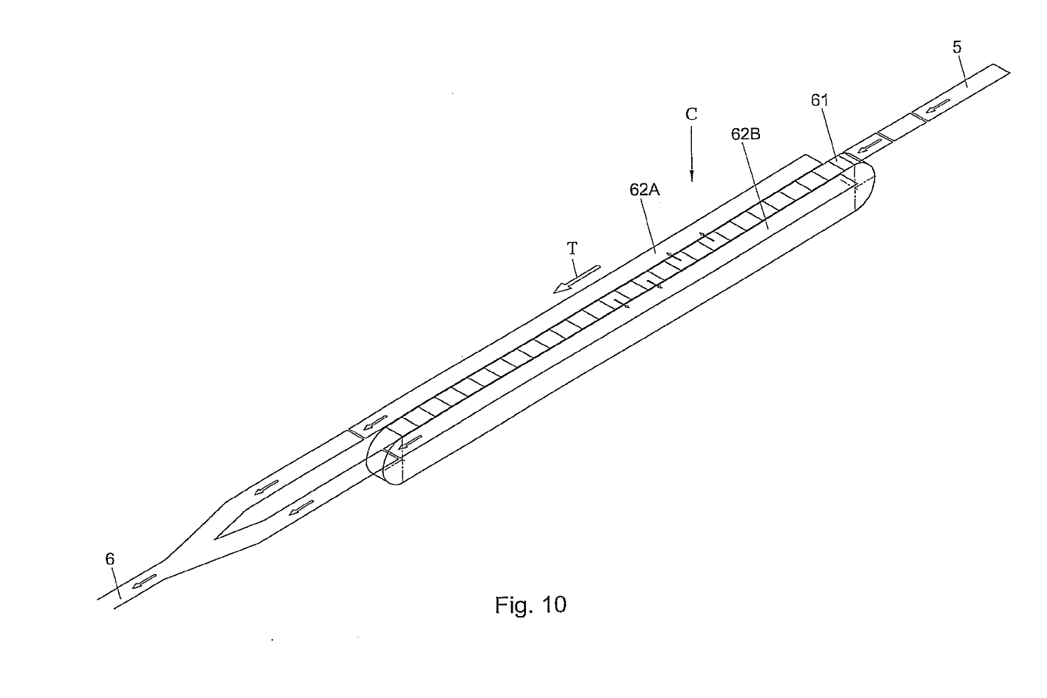

FIG. 10 shows a second part of the system represented in FIG. 1, comprising an after-sorting device; and

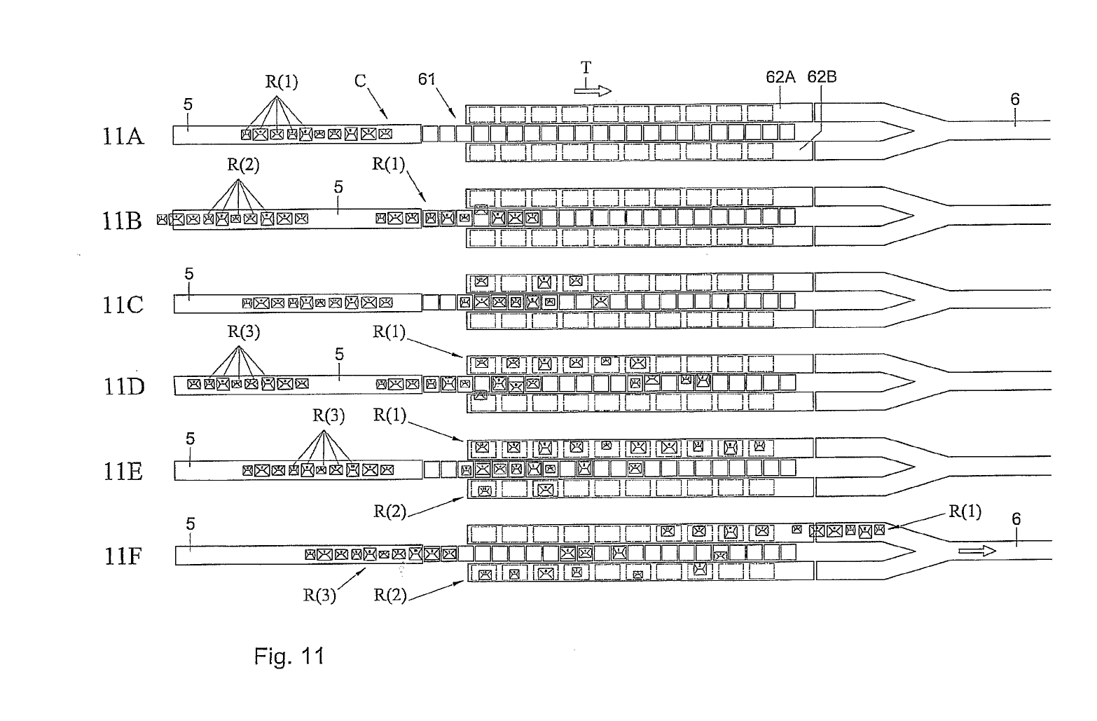

FIG. 11 shows an operation of the after-sorting device represented in FIG. 10.

In the present application, identical or corresponding features are indicated with identical or corresponding reference numerals.

FIG. 1 shows an exemplary embodiment of a system for arranging and/or automatically storing objects P, for instance products, boxes and/or the like. The system is intended for, for instance, forming predetermined stacking patterns, such that the objects can be stacked rapidly and stably. Such a stacking pattern can for instance comprise or one or more objects. In particular, at least several of these objects can have different shapes and/or dimensions and/or masses. The system may further be designed for determining substantially horizontal stacking patterns.

The system can be provided with, for instance, a number of object suppliers, not represented, comprising, for instance, one or more destackers, singulators, a zone for manual object supply and/or the like. The object suppliers may be provided with a number of destacking stations for destacking stacks of identical objects (mono pallets, for instance).

The present system comprises a supply device A for supplying objects P, for instance objects coming from these object suppliers. Such a supply device A can be designed in different manners, and comprise, for instance, one or more supply tracks. In the exemplary embodiment, the supply device is provided with a number of supply conveyors 4, which can extend for instance at different vertical supply levels relative to each other. Downstream of the supply device A, a presorting device B—also called sorting buffer—is disposed. This presorting device B is provided with a large number of endless object group conveyors 10 which are configured for holding objects P in a large number of respective object groups. The system may be provided with at least two such object group conveyors, for dividing objects into at least two different object groups. In particular, the system can at least be provided with 10 object group conveyors, and, in particular, with at least 50, 100 or 1000 object group conveyors. The present object group conveyors 10 are in particular intended for providing respective substantially flat buffer channels, for collecting the objects P in respective rows.

Each object group conveyor 10, or an associated buffer channel, can be associated, during use, with a part of a stack of objects to be formed, for instance with a horizontal stacking pattern of an object stack to be formed. The system can, in particular, be configured for collecting the different stacking patterns, at least associated object groups, during use, first, on respective, different of these object group conveyors 10 (buffer channels) before the thus grouped objects P undergo an after-sorting step and/or are stacked. Preferably, the system is modularly extendible, while a desired number of additional object group conveyors can, for instance, be added to an already existing system in a simple manner.

The object group conveyors 10 are each separately disposed at a fixed position in a suitable space, and/or, for instance, a fixed position relative to a supply device A mentioned.

In particular the object group conveyors 10 can also be disposed at different vertical levels, for instance one above the other. In FIG. 1, substantially only one of the levels of the object conveyors 10 is visible.

Each endless object group conveyor 10 can be designed in several manners and comprise, for instance, a conveyor belt, a chain conveyor, a conveyor provided with endless belts and/or a different type of conveyor. During use, the objects can for instance simply be held with undersides on upper bearing surfaces or bearing parts of these conveyors 10. In a further elaboration, these conveyors 10 are each of relatively narrow design, measured in horizontal cross direction of the conveyor 10, for saving space.

Preferably, conveying surfaces, or object bearing surfaces of said object group conveyors 10 each extend substantially horizontally, in order that the objects P can be held thereon in a stable manner and without relative thrust. During use, a substantially horizontal row of objects P borne by object group conveyor 10 can comprise one or more objects.

The exemplary embodiment is further provided with a sorting device C, for instance a reshuffle sorter, disposed downstream of the object group conveyors 10. A number of discharge conveyors 5 are provided for discharging objects P from the different levels of the object group conveyors 10, and for supplying these to this sorting device C. The sorting device C is designed in particular for bringing the object row coming from the object group conveyor into a predetermined order, if this row is not yet in this order.

Downstream of the after-sorting device C, for instance an object stacker D is provided. The stacker D can be designed in different manners. It is advantageous when the stacker D is designed for stacking objects onto each other in substantially horizontal stacking patterns. Such a device is known from Dutch patent NL 1025826, the contents of which is understood to be fully incorporated in the present application by reference. The stacker D can for instance be designed for, first, bringing object rows supplied to this stacker D in the stacking patterns, for, then, bringing the thus formed patterns successively onto each other.

The system can further be provided with a control (not represented). This control serves, for instance, for controlling the conveyors, for controlling the presorting device B and after-sorting device C, for controlling the stacker D, for regulating the supply of objects P, for, optionally, sorting objects P and/or for determining the positions of objects in the system. The control can comprise, for instance, one or more controllers, computers, calculating means, memory means, software, one or more suitable formation and stacking algorithms and the like. Preferably, the control is designed for regulating the system such that desired stacking patterns are formed for forming stable stacks, in particular if the objects P have different shapes and/or sizes and in particular if the stacks to be formed are provided with one or more objectless spaces.

FIGS. 2-6 show in more detail a presorting part of the system represented in FIG. 1. In FIG. 2, four of a larger series of substantially parallel object group conveyors 10 are represented. This series of parallel object group conveyors 10 is located, for instance, on one of the vertical levels mentioned. The object group conveyors 10 extend in this level, for instance substantially parallel relative to each other, and substantially at right angles relative to a part of a supply conveyor 4.

In the exemplary embodiment of FIGS. 2-6, the series of object group conveyors 10 extends between a supply conveyor 4 and a discharge conveyor 5. The supply conveyor 4 extends along first end parts of each of the object group conveyors 10 of the respective series, and the discharge conveyor 5 extends along second end parts, remote from the first end parts, of each of the object group conveyors 10. With the supply conveyor 4 or discharge conveyor 5, respectively, the objects P can be supplied to the object group conveyors 10 or be discharged therefrom, respectively. The supply and discharge conveyor 4, 5 can extend, for instance, along a first direction X, and the object group conveyors 10 each along a second direction Y. Further, object group conveyors 10 can for instance extend obliquely relative to the supply conveyor 4 and/or the discharge conveyor 5.

As shown in FIGS. 2-6, each object group conveyor 10 is drivable, in particular for moving an object group held by the conveyor 10, during, for instance, reception by this conveyor 10 of an object and/or for the purpose of dispensing an object or object group by this conveyor 10. To this end, the object group conveyors 10 are however not provided with separate respective drives, but only of associated operating mechanisms 11. In the exemplary embodiment, each time, two operating mechanisms 11 per object group conveyors 10 are provided, i.e. one at each end part of this conveyor 10. The object group conveyors 10 can be considered as being “drive-less” conveyors. In this manner, each object group conveyor 10, or buffer path supplied thereby, can be provided substantially without electric wires and the like.

The system is provided with first drives 20 for driving the different object group conveyors 10 of a series of object group conveyors, utilizing the operating mechanisms 11 mentioned. To this end, each first drive 20 can be brought into different driving positions, and in particular movable between respective driving positions for driving, each time, only one of these object group conveyors 10. A first position of each of the drives 20, for operating a first object group conveyor 10(1), is represented in FIGS. 2-6. In this driving position, each drive 20 is located adjacent the conveyor 10(1) to be driven, and in particular substantially opposite an end wall of this conveyor 10(1). Another (second) position of a drive 20, for operating another (second) object group conveyor 10 of the respective series of conveyors 10, is not represented in the Figures.

Each of the vertical levels mentioned of object group conveyors 10 can be provided with, for instance, such first drives 20. In addition, a first drive 20 can for instance be movable between the different levels of object group conveyors 10, for operating object group conveyor 10 of the different levels. The system may be provided with a lifting mechanism (not shown) for moving a first drive 20 between different levels.

The system is in particular provided with conveying mechanisms 30, 31, 35, 36 for moving associated first drives 20 between the desired driving positions. Each conveying mechanism is preferably provided with a movable drive carrier 30, which carrier 30 is provided with a first drive 20. In the exemplary embodiment, each drive carrier 30 can be moved to positions adjacent object group conveyors 10, in particular to positions located near and/or opposite end parts of these conveyors 10, for bringing a first drive 20 to a suitable driving position.

With the present exemplary embodiment, a first conveying mechanism 30A, 31A, 35A, 36A is provided with a first drive carrier 30A for moving a respective first drive 20 between the first end parts of said object group conveyors 10, and with second conveying mechanism 30B, 31B, 35B, 36B with a second drive carrier 30B, for moving a respective first drive 20 between the two end parts of the object group conveyors 10.

As shown in FIG. 2, the supply conveyor 4 extends—in the exemplary embodiment—between the path of the first drive carrier 30A and the series of product group conveyors 10, at least viewed in a top plan view. In addition, the path of the second drive carrier 30B extends between the discharge conveyor 5 and the series of product group conveyors 10.

Each conveying mechanism can be designed in different manners. In the exemplary embodiment, each mechanism is provided with a guide 31 for guiding a drive carrier 30 between desired positions. The drive carrier 30 comprises, in particular, a trolley 30 movable along and/or over guide rails 31. The trolley 30 may be provided with a number of wheels 39 for riding the trolley 30 along the rail 31. As can be seen in FIG. 6, for instance the guiding wheels 39 can ride over a top side of a rail 31. In addition, the wheels 39′ can engage rail longitudinal sides, for providing stability in cross direction (Y).

Each conveying mechanism can further for be provided with, for instance, an endless belt 35A, 35B, for instance a geared belt or the like, and with a belt drive 36A, 36B for moving the belt 35A, 35B. The respective trolley 30A, 30B can be suitably coupled to the endless belt 35A, 35B, for movement between desired positions under the influence of the belt drive 36A, 36B. With such a geared belt, a durable, substantially form-locked drive of the trolley may be obtained.

Each first drive 20 of each trolley 30A, 30B is provided with a conveyor operating part 21, for engagement on a conveyor operating mechanism 11 for operation of the respective object group conveyor 10, at least when the first drive 20 is in a respective driving position, adjacent the conveyor 10. In particular, a first drive 20 is designed for cooperation with the object group conveyors 10, with the first drive in a respective driving position, utilizing a suitable coupling and/or engagement, by means of, for instance a belt/wheel coupling, a geared belt/toothed wheel coupling, by means of a belt/belt coupling and/or by means of a wheel/wheel coupling, utilizing one or more friction wheels, gear wheels, crown wheels and/or the like.

Each drive 20 can further be provided with, for instance, means for moving a conveyor operating part 21 relative to the respective drive bearing trolley 30, and for driving the conveyor operating part 21. With the exemplary embodiment, each first drive 20 comprises a movable or slide-out arm 22, and an arm drive M3 for moving this arm 22. With the exemplary embodiment, this arm 22 is movable along the second direction Y, away from the trolley 30 and towards the trolley 30. A conveyor operating part 21 is provided at or near an end wall of the drive arm 22. Further, each first drive 20 is provided with, for instance, a conveyor operating part drive M4 for driving the conveyor operating part 21. This arm drive M3 and conveyor operating part drive M4 can each be designed in different manners, and comprise, for instance, suitable electric motors, transmissions, coupling mechanisms, guides and the like.

As shown in FIGS. 2, 3 and 6, each operating mechanism 11 of an object group conveyor 10 can be provided with, for instance, an endless belt 12, for instance a geared belt, which is guided around the guide wheels 13. The endless belt 12 is coupled, by means of a coupling, to the respective object group conveyor 10 such that the object group conveyor 10 is movable under the influence of the movement of the belt 12.

The conveyor operating part 21 of the first drive 20 can then for instance be designed for bringing in motion the endless belt 12 of an operating mechanism 11 of an object group conveyor 10, when the operating part 21 has been brought by the driving arm 22 into a position moved towards this belt 12, and engaging the belt 12 (see FIG. 6). Thereto, the conveyor operating part 21 can comprise, for instance, a wheel, rotatable by a wheel drive M4, a disc, gear disc or the like.

In the present system, each trolley 30 is advantageously further provided with an object manipulator 50 for manipulating objects, for instance for manipulating objects P located near the trolley 30. The first trolley 30A is in particular provided with a first object manipulator 50A which is configured for moving at least one object P from the supply conveyor 4 to an object group conveyor 10 driven by the respective first drive 20. The second trolley 30B comprises a second object manipulator 50B which is configured for moving at least one object P from an object group conveyor 10, driven by the respective first drive 20, to the discharge conveyor 5.

In particular the first object manipulator 50A is provided with a manipulator part 52, movable by at least a second drive M1, M2, which is for instance coupled to a slide-out arm. The manipulator part 52 can be brought in a releasing position, moved away from the supply conveyor 4 for allowing the passage of objects P, and in a manipulating position moved towards the supply conveyor 4 for receiving objects P from the supply conveyor 4 and move them to a nearby object group conveyor 10. The manipulator part 52 can be designed in different manners, and comprise, for instance, a slider, pusher, stop and/or the like.

The manipulator 52 part represented in the Figures is of block-shaped design, with a triangular horizontal cross section. The present manipulator part 52 is provided with a side proximal to the supplied objects P, which extends at an inclination or diagonally relative to the conveying direction of the supply conveyor 4. The manipulator part 52 can also be formed differently, having, for instance, a concave, bevelled or curved side contacting the supplied objects P. The manipulator part 52 can further be movable in different manners, in different directions, relative to the trolley 30A. In the exemplary embodiment, the first manipulator 50A is provided with a second drive M1 for moving the manipulator part 52 in a direction X′ parallel to the supply conveyor 4, and with a second drive M2 for moving the manipulator part 52 in a direction Y′ transversely to the supply conveyor 4. The second drives M1, M2 can be coupled to the manipulator part 52 in different manners for moving that part 52 relative to the trolley 30A, by means of, for instance, suitable transmissions, coupling mechanisms, guides and the like.

In particular the second object manipulator 50B is provided in a simple manner with an endless conveyor 50B. The latter conveyor 50B extends in particular between opposite sides of the second trolley 30B, transversely to a conveying direction of the discharge conveyor 5. The second trolley 30B comprises a second drive M5 for driving the manipulator conveyor 50B.

In particular a first drive 20 and an object manipulator 50 of each trolley 30 are designed for mutual cooperation, for moving objects P between a supply and/or discharge conveyor 4, 5 and the object group conveyors 10.

During use, for instance, an object group conveyor 10 can be driven by the first drive 20 of the first trolley 30A for moving one or more objects P held by this conveyor 10 from the supply conveyor 4, while the respective object manipulator 50A moves one or more objects P towards this object group conveyor 10. Here, the supply conveyor 4 can also be in operation for effecting the movement of the one or more products P. It is further advantageous when the manipulator part 52 is moved by the respective second drives M1, M2, such that an object P can be moved away from the supply conveyor 4 in a gradual path, for instance along a curve.

It is further advantageous when the object P is arranged substantially centrically on the object group conveyor 10 for the purpose of stability, and preferably with a longest dimension (a width direction) of the object P transverse to the object group conveyor 10 for the purpose of saving space. Placing an object P substantially centrically on an object group conveyor 10 can for instance be achieved by bringing the manipulator part 52 at a position suitable for such placing above the supply conveyor 4. Upon supply of a relatively small object—at least measured in cross direction of the supply conveyor 4—the manipulator part 52 can reach over, for instance, a relatively large distance over the supply conveyor 4 for contacting the object at a suitable moment and bringing it to the object group conveyor 10. On the other hand, upon supply of a relatively large object, the manipulator part 52 can reach over, for instance, a relatively small distance over the supply conveyor 4, for contacting this object at a suitable moment and bringing it to the object group conveyor 10. This depends, inter alia, on the shape of the object and the shape and dimensions of the manipulator part 52.

It is further advantageous when the first drive 20 and the object manipulator 50A of the first trolley 30A are designed for positioning objects P at a distance from each other on the supply conveyor 4.

Also, the object group conveyor 10 can be driven by the first drive 20 of the second trolley 30B for moving objects P, held by this conveyor 10, towards discharge conveyor 5, while the endless manipulator conveyor 50B simultaneously moves one or more objects P from this object group conveyor 10 and supplies them to the discharge conveyor 5.

Furthermore, the first trolley 30A can be relatively rapidly movable in that this trolley 30A remains unloaded during use, at least bears no objects P to manipulate. In this manner, the trolley with the parts borne thereby can be of particularly lightweight design, for instance for attaining a high speed. It is, for instance, advantageous when a conveying mechanism 30, 31, 35, 36 and a respective trolley 30 are configured such that the trolley with the respective first drive 20 and object manipulator 50 is movable at a speed of at least 5 m/s, and in particular at least 10 m/s between desired driving positions.

Above-cited first drives 20, M3, M4, second (manipulator) drives M1, M2, M5 and/or belt drives 36A, 36B can be controllable under the influence of a control mentioned of the system. The system can further be provided with communication means for the purpose of communication between such drives and the control. Also, feed means can be provided for supplying current to the drives. Feed and/or a control connections to each of the movable trolleys 30A, 30B can be provided in different manners. For instance, each trolley 30 can be provided with a storage battery, or can be coupled to a power supply by means of sliding contacts, a sliding cable, and/or cable carrier feed or the like. Further, drives of each trolley 30 can for instance be remote-controlled, utilizing suitable transmitters and receivers. A trolley 30 can further be provided with other means to be electrically fed, for instance one or more signal givers, sensors, feelers, connection means, electronics, and/or the like, which can be fed by such feeds.

It is preferred that a wireless connection be used for providing each trolley 30 both with current and with control signals. Such a connection comprises, for instance, a contactless connection, for instance an inductive connection with track antenna parts 38 extending along the track of the trolley and trolley antenna parts 37 provided on the trolley 30. The track antenna parts 38 can generate an electromagnetic field that can be received by the trolley antenna parts 37 and be converted into current, for electrically feeding particular parts of the trolley 30, for instance the drives and/or the other means to be electrically fed. The electromagnetic field can further be provided with control signals, which can also be received via the trolley antenna parts 37, and can be processed, for instance, for having the various drives M1-M5 of the trolley 30 carry out desired maneuvers or for controlling other parts of the trolley or for communicating therewith.

During use of the present exemplary embodiment, objects P, for instance objects P to be stacked, can be carried via a supply conveyor 4, at a relatively high speed along the object receiving parts of a series of object group conveyors 10, at least the buffer channels presented thereby. The objects P are to be distributed, in for instance a predetermined manner, for instance in an order defined by the system control, over the different buffer channels provided by the different object group conveyors 10.

Moving an object P from the supply conveyor 4 to a desired object group conveyor 10(1) can be carried out by the object manipulator 50A and the first drive 20 of the first trolley 30A jointly. To this end, the trolley 30A is simply moved by the respective belt drive 36A, at high speed, over the rails 31A to the respective object group conveyor 10(1), for instance at the moment the respective product P has been brought near the object group conveyor 10(1) by the supply conveyor 4, or sooner. Then, the first drive 20 of the first trolley can drive the object group conveyor 10(1), through cooperation of the conveyer operating part 21 and the operating mechanism 11 of the conveyor 10(1). Through this operation, objects that may already be present on this object group conveyor 10(1) can be moved from the supply conveyor 4. Simultaneously, the first manipulator 50A can move a (subsequent) object P from the supply conveyor 4 and bring it onto the desired object group conveyor 10(1). To this end, the manipulator part 52 can simply be brought into the path of this object for guiding, sliding and/or pushing the object P to the object group conveyor 10(1). Preferably, an advancement of the supply conveyor 4 contributes to the transfer of the object P onto the object group conveyor 10(1).

As mentioned, it is advantageous when the objects P are positioned at a distance from each other and substantially centrally on the object group conveyor 10. Further, for instance positioning sensors can be provided for checking whether objects P are or have been positioned at desired, stable positions on a group conveyor 10, for instance optical sensors, feeler sensors, acoustic sensors, electric sensors and/or other sensors.

In this manner, the first trolley 30A can successively be placed between a large number of different driving positions, for, each time, driving only one object group conveyor 10, and for bringing one or more objects onto this object group conveyor 10.

When a desired group of objects has been collected on an object group conveyor 10, the group can be brought, for instance in one go, onto the discharge conveyor 5. To this end, the second trolley 30B can be moved to a dispensing part of the object group conveyor 10. Then, the respective object group conveyor 10 can simply be driven by the first drive 20 of the second trolley 30B, for bringing the group of objects via the second trolley 30B to the discharge conveyor 5. Here, the endless conveyor 50B can serve as bridge between the object group conveyor 10 and the discharge conveyor 5. Then, the discharge conveyor 5 can supply the thus collected group or row of products to, for instance, the sorting station C and/or the stacking device D. In one elaboration, a row of products can thus be brought, in one go, onto the discharge conveyor 5. Alternatively, the second trolley may be used for discharging a limited number of objects from a group conveyor.

When the objects P have been arranged at a distance from the object group conveyor 10, during discharge, the objects can simply be optically distinguished and/or be counted, so that the discharge of the group can be carried out rapidly. To this end, suitable sensors 19 can be provided, for instance optical sensors, photocells, encoders, feelers, acoustic sensors and/or the like. Such sensors 19 may be disposed near take-up parts and/or dispensing parts of the group conveyors 10. In the exemplary embodiment, such sensors 19 are provided in and/or on housings of the operating mechanisms 11. Such sensors 19 can also be used for, for instance, positioning objects at desired or predetermined mutual distances.

The order of collecting and distributing objects P on the object group conveyors 10 and, then discharging the objects P from the conveyors 10 again, can be such that, for instance, suitable stacks can be formed with the objects.

FIG. 7 shows a part of an alternative exemplary embodiment. The exemplary embodiment shown in FIG. 7 is distinguished from the exemplary embodiment represented in FIGS. 1-6 in that each time, two object group conveyors 10A, 10B are arranged in alignment, instead of one such conveyor 10. The upstream object group conveyor 10A, which extends from the supply conveyor 4, can for instance be drivable only by the first drive of the first trolley 30A. In addition, the upstream and downstream conveyor can for instance be simultaneously drivable by a drive of the second trolley 30B. Between the two group conveyors 10A, 10B, disposed in alignment, a suitable automatic conveyor coupling 60 may be provided, for coupling the conveyors 10A, 10B to each other so as to be drivable only under the influence of the upstream conveyor 10B. The conveyor coupling 60 can be designed for coupling the respective conveyors 10A, 10B in a non-drivable manner in case only the upstream group conveyor 10A is driven.

In this manner, a group of objects can be collected on a first buffer path part L1 provided by an upstream group conveyor 10A, in particular under the influence of a first drive 20 and object manipulator 50A of the first trolley 30A. A thus collected group can then be transferred under the influence of the first drive of the second trolley 30B to a second buffer path part L2 provided by the downstream group conveyor 10B, for instance for temporary storage. Then, first buffer part L1 is available again so that a new object group can be collected thereon. The use of this alternative exemplary embodiment can further be the same as the use of the exemplary embodiment shown in FIGS. 1-6.

FIG. 8 shows a part of another alternative exemplary embodiment. The exemplary embodiment shown in FIG. 8 is distinguished from the exemplary embodiment represented in FIGS. 1-6 in that a supply/discharge conveyor 104 is provided which extends on one side along end parts of each of the object group conveyors 10. This supply/discharge conveyor 104 serves for supply of objects to a series of object group conveyors 10, as well as for discharge of objects from this series. In this case, the object group conveyors 10 are provided with one end part, located adjacent the supply/discharge conveyor 104, for reception as well as for discharge of objects P. Between the supply/discharge conveyor 104 and the end parts of the group conveyors 10 extends a track of a drive bearing trolley 30′. This trolley 30′ is provided with a first drive M3, M4 with an operating part 21 for operating the group conveyors 10, and with two object manipulators. One object manipulator comprises a conveyor belt 50′ with a respective second drive M5, and the other object manipulator comprises a transfer arm 52′ that can be brought over the supply/discharge conveyor 104, with respective second drives M1, M2. The transfer arm 52′ is provided with, for instance, an endless belt for moving objects P from the supply/discharge conveyor 104 to the conveyor belt 50′. These two object manipulators of the trolley 30′ can cooperate for moving objects between the supply/discharge conveyor 104 and a group conveyor 10, in particular when this group conveyor 10 is driven by this first drive.

FIG. 9 shows a part of another alternative exemplary embodiment. The exemplary embodiment shown in FIG. 9 is distinguished from the exemplary embodiment represented in FIG. 8 in that each object group conveyor 10′ is provided with a first end part located adjacent the supply/discharge conveyor 104 for reception of objects, and a second end part, also located adjacent the supply/discharge conveyor 104, for discharge of objects. Each object group conveyor provides, for instance, a substantially U-shaped conveying track. A movable trolley 30″ is provided, with drives for driving the group conveyors, and for bringing objects P from the supply/discharge conveyor 104 onto the receiving part mentioned. As shown in the Figure, the trolley 30″ can be designed to be, for instance, similar to the first trolley 30 of the exemplary embodiment shown in FIGS. 1-6.

As mentioned, the system can further be provided with an after-sorting device C arranged downstream of the object group conveyors 10. This sorting device C can be designed for bringing an object row coming from an object group conveyor 10 into a predetermined order. FIGS. 10-11 show a possible exemplary embodiment of the sorting device C. In this case, the sorting device is provided with:
a first (middle) track 61 (a “main road”) for receiving an object row R;
two tracks 62A, 62B (“service roads”) extending along the first track 61 and on either side of this first track 61; and
one or more object movers for moving objects from a row part present on the first track and move them in a predetermined order on a second track.

Preferably, upper conveying surfaces of the first track 61 and second tracks 62 extend substantially horizontally. These tracks 61, 62A, 62B extend, in particular, parallel to each other. Preferably, the first track mentioned is provided with a first respective endless conveyor 61, and the two tracks are each provided with a second endless conveyor 62. These tracks can be provided by, for instance, upper conveying parts of the conveyors 61, 62, at least by object bearing sides turned upwards of the conveyors 61, 62.

The object movers mentioned can be designed in different manners, and form part of, for instance, the first endless conveyor. In the exemplary embodiment, the first track 61 is for instance provided by a vertical cross belt sorter 61 known per se from practice. Additionally, the first track can for instance comprise a different type of sorter, for instance a “shoe sorter” or “tiltway sorter” or the like, know per se.

The first conveyor 61 of the exemplary embodiment comprises in particular an upper part going one side for moving objects in a main conveying direction T, and a lower, returning part. The first endless conveyor 61 is preferably divided in successive segments. Each of these segments itself is provided with, for instance, a cross belt for moving an object present on that segment in cross directions relative to the conveying direction T, towards the second tracks 62. Each of these second tracks 62 may be provided with a preferably endless receiving conveyor 62, for receiving and temporarily holding objects from the middle conveyor 61. Each receiving conveyor 62 can comprise a modular conveyor belt, or a different type of conveyor.

During use, each time, one segment of the first conveyor can be used for receiving an object, which is represented in the drawing. With a relatively long object however, two or more successive segments of the first conveyor 61 may be used for receiving this long object.

FIG. 11 shows the use of the sorting device C. Here, objects can be supplied by a conveyor 5, for instance a discharge conveyor mentioned, in rows R to the first, middle conveyor 61. The objects P may already have been grouped according to a stacking pattern of a stack to be formed, in these rows R, but may, per row R, not yet be in order of stacking for the purpose of stacking itself, or for the purpose of bringing objects P in stacking patterns.

The sorting device C offers a high capacity. Here, each time, one or more segments of the first endless conveyor 61 can be used for receiving a subsequent object of a row of objects, depending on the dimensions of that object. The sorting device C can bring the objects P rapidly and simply, per row R, in a suitable stacking order, predetermined by, for instance, the control. In FIG. 11A, a first row of objects R(1) is supplied to the first conveyor 61. This row of objects R(1) belongs to, for instance, a first layer of a stack to be formed. The objects are brought by the first conveyor 61 on one of the two receiving conveyors 62 such that the row order of these objects is brought in a desired order, see FIGS. 11B-11E. After rearrangement a row of objects R(1), the row R(1) can be brought by the respective receiving conveyor 62A to a discharge conveyor 6 for discharge to, for instance, a stacking station D (see FIG. 1 and FIG. 11F).

FIGS. 11B-11F further show that on the other receiving conveyor 62B, a subsequent row of objects R(2) can be collected in a desired order. Bringing a subsequent row of objects R(2) onto the first conveyor 61 can already be effected at the moment a part of a previous row R(1) is still downstream on the first conveyor 61. The process can then repeat itself, while a third row R(3) is rearranged by the first conveyor sorter 61 on the first track 62A, for instance when the second row R(2) is still being brought onto the second track 62B.

Through the use of an above-described presorting device B and an after-sorting device C (see FIG. 1), a method for arranging objects in substantially horizontal stacking patterns can be carried out. The method can comprise: a first sorting step to be effected by presorting device B, in which the objects are divided into groups, in particular rows, which groups correspond to the stacking patterns to be formed. In a second step, the groups can be brought into rows by the after-sorting device C, with an order suitable for stacking. The objects of one stack to be formed can first be arranged and stored in predetermined groups on, for instance, the presorting device B, while the thus formed groups can be carried, on demand, to the after-sorting station C if forming an associated stack is desired. In particular, at least several of the objects can have different forms and/or dimensions. Such objects can be sorted well and rapidly by the method and the system.

An above-described system and method can be used for, for instance, rapidly destacking monopallets (depalletizing) The system can be provided with various supply devices or conveyors for feeding the objects to a presorting and/or after-sorting device B, C. The system can further be provided with means (not represented) for rotating or repositioning objects to what may be a desired position. The system can be of relatively durable and inexpensive design. Furthermore, the system can arrange the objects rapidly into the desired orders or rows.

It will be clear to the skilled person that the invention is not limited to the described exemplary embodiments. Various modifications are possible within the framework of the invention as set forth in the following claims.

For instance, the system can be disposed at different locations, for instance in working environments such as storage houses and production buildings, and in cold stores, temperature controlled environments, transfer areas, fixed or mobile, on board of a vehicle, vessel or plane and/or other environments. Furthermore, parts of the system can for instance be movable relative to each other. The presorting device B can be fixedly arranged, for instance in a depot or the like. A supply and/or discharge conveyor can for instance be movable relative to the presorting device C, for instance when such a conveyor is provided on a vehicle, vessel or plane. Conversely, such a presorting device B may be mobile.

Further, a first drive can be movable between different driving positions for, each time, driving only one object group conveyor 10. Alternatively, a first drive can for instance drive only a limited number of object group conveyors 10 of a total number of object group conveyors 10, when the first drive 20 has been brought into a particular driving position. Further, for instance only one first drive can be movable along end parts of the object group conveyors 10 for operating these conveyors 10. Additionally, a limited number of such first drives 20 may be provided, which are movable along end parts of object group conveyors 10 for operation of the conveyors 10, for instance fewer first drives 20 than a total number of object group conveyors 10 to be driven by these drives 20. For instance, several drive carriers can be movable along one guide or rails mentioned, or several guides or rails can be provided for bringing several drive carriers to suitable positions.

The system can further be provided with for instance, object tracing and/or recognizing means known per se, for instance a system utilizing labels, RF-ID identification and/or the like.

Furthermore, a first drive mentioned can be movable for driving different conveyors.

In addition, the first drive can be brought in, for instance, at least a first and second position for driving only at least a first or second object group conveyor, respectively, without moving the first drive, by providing the drive with controllable couplings for coupling the drive to each of these conveyors separately. The first drive can be provided with, for instance, a drive shaft, which, with the drive coupling in a first position, is coupled only to the first object group conveyor and, with the drive coupling in the second position, to only the second object group conveyor. These controllable coupling can be designed in different manners, and comprise, for instance, slip couplings and/or the like.

The present system is further preferably suitable for arranging and/or storing mixed objects, for instance on the group conveyors mentioned. In addition, the system can for instance be used for arranging and/or storing only the same objects in groups. Further, one or more of the group conveyors can be used for, for instance, holding only objects of one particular type, one dimension, one shape and/or one mass.

1. A system for arranging and/or storing objects, for the purpose of, for instance, forming stacking patterns, comprising:
at least two object group conveyors which are configured for holding objects (P) in at least two respective object groups, while each object group conveyor is drivable, in particular for moving an object group held by this conveyor; and
at least a first drive for driving the at least two object group conveyors;
wherein the first drive can be brought in at least a first and second position for driving only the first or second object group conveyor, respectively.

2. A system according to claim 1, wherein each object group conveyor itself is not provided with a conveyor drive.

3. A system according to claim 1, wherein conveying surfaces, or object bearing surfaces, of said object group conveyers extend substantially horizontally.

4. A system according to claim 1, wherein at least several of said objects have different shapes and/or dimensions, and/or masses.

5. A system according to claim 1, wherein at least several of said objects have the same shapes, dimensions and masses.

6. A system according to claim 1, configured for disposing objects substantially centrally on each object group conveyor, viewed in a transverse direction of the respective object group conveyor.

7. A system according to claim 1, wherein the first drive is movable between at least a first driving position for driving only the first object group conveyor, and a second driving position for driving only the second object group conveyor.

8. A system according to claim 7, provided with at least one conveying mechanism for moving a said first drive between the at least first and second driving position, wherein the conveying mechanism is provided with a movable drive carrier, which carrier is provided with said first drive.

9. A system according to claim 8, wherein the drive carrier is movable to positions located near object group conveyors, in particular to positions located adjacent and/or opposite end parts of these conveyors, for bringing the first drive to said driving positions.

10. A system according to claim 8, wherein further the drive carrier is provided with an object manipulator for manipulating objects, for instance for manipulating objects (P) located adjacent the drive carrier.

11. A system according to claim 1, provided with at least one supply and/or discharge conveyor for supplying the objects (P) to the object group conveyors and/or discharging them therefrom.

12. A system according to claim 39, wherein the object manipulator is configured for moving at least an object (P) from the supply and/or discharge conveyor to an object group conveyor driven by the first drive, and/or conversely for moving at least an object (P) from an object group conveyor driven by the first drive to the supply and/or discharge conveyor.

13. A system according to claim 12, wherein the object manipulator is provided with a manipulator part movable by at least a second drive (M1, M2), wherein the manipulator part can be brought in a releasing position moved away from the supply and/or discharge conveyor for allowing passage of objects (P), and in a manipulating position moved towards the supply and/or discharge conveyor for receiving objects (P) from the supply and/or discharge conveyor and moving them to a nearby object group conveyor.

14. A system according to claim 12, wherein the object manipulator is provided with an endless conveyor, while the latter conveyor extends in particular between opposite sides of the drive carrier.

15. A system according to claim 12, wherein a said first drive and an object manipulator of a said drive carrier are designed for mutual cooperation for moving objects (P) between a said supply and/or discharge conveyor and said object group conveyors.

16. A system according to claim 12, wherein a said first drive and an object manipulator of a said drive carrier are designed for positioning objects (P) at a distance from each other on a said supply and/or discharge conveyor.

17. A system according to claim 11, provided with a first supply/discharge conveyor which extends along first end parts of each of the said object group conveyors, and with a second supply/discharge conveyor which extends along second end parts of each of the said object group conveyors.

18. (canceled)

19. A system according to claim 11, provided with one supply/discharge conveyor which extends along end parts of each of the said object group conveyors.

20. A system according to claim 19, wherein a number of the object group conveyors is provided with one end part located adjacent the supply/discharge conveyor, for reception as well as and discharge of objects.

21. A system according to claim 19, wherein a number of the object group conveyors are provided with a first end part for reception of objects, located adjacent the supply/discharge conveyor, and a second end part for discharge of objects, also located adjacent the supply/discharge conveyor, while the object group conveyor comprises, for instance, a U-shaped conveying track.

22. A system according to claim 8, wherein said conveying mechanism is provided with a guide for guiding the drive carrier between desired positions, while the drive carrier comprises, in particular, a trolley movable along and/or over guide rails.

23. A system according to claim 8, wherein the conveying mechanism and the drive carrier are configured such that the first drive is movable between said driving positions at a speed of at least 5 m/s, in particular at least 10 m/s.

24. A system according to claim 8, wherein said conveying mechanism is provided with an endless belt, for instance a geared belt, and with a belt drive for moving the belt, while the first drive is coupled to the endless belt so as to be moved under the influence of the belt drive between said driving positions.

25. A system according to claim 1, wherein each object group conveyor is provided with an operating mechanism which operating mechanism can be engaged by a conveyor operating part of the first drive for operating the object group conveyor, at least when the first drive is in a respective driving position.

26. A system according to claim 1, wherein the first drive is designed for cooperation, in a respective driving position of the first drive, with an object group conveyor, by means of a belt/wheel coupling, for instance a geared belt/toothed wheel coupling, by means of a belt/belt coupling and/or by means of a wheel/wheel coupling.

27. A system according to claim 1, wherein said object group conveyors comprise endless conveyors, for instance conveyor belts.

28. A system according to claim 1, designed for determining substantially horizontal stacking patterns, wherein the system is configured for collecting the with the different associated objects stacking patterns, during use, on respective, different said object group conveyors.

29. A system, for instance a system according to claim 1, provided with a sorting device (C), wherein the sorting device is designed for bringing an object row in a predetermined order, the sorting device being provided with:
a first track for receiving an object row, while the first track comprises, in particular, a first endless conveyor;
at least a second track extending along the first track, which second track comprises in particular a second endless conveyor; and
one or more object movers for moving objects from a row part located on the first track, and placing them in a predetermined order on a second track, while the said first track is provided, in particular, with said object movers.

30. A system according to claim 1, further provided with at least one device for stacking objects, while device is arranged downstream relative to said object group conveyors.

31. A system according to claim 1, at least provided with 10 object group conveyors, and, in particular, at least 50, 100 or 1000 object group conveyors.

32. A system according to claim 1, wherein at least a number of said object group conveyors are arranged substantially parallel to each other, for instance in a series.

33. A system for arranging and/or storing objects, for instance a system according to claim 1, comprising:
at least two object group conveyors which are configured for holding objects in at least two respective object groups;
a supply and/or discharge conveyor for carrying objects (P) to be arranged along object receiving parts and/or object discharge parts of the object group conveyors; and
an object manipulator for moving objects between the supply conveyor and the object group conveyors,
wherein the object manipulator is movable between at least a first moving position for moving objects only between the first object group conveyor on the one hand and the supply and/or discharge conveyor on the other hand, and a second moving position for moving objects only between the second object group conveyor on the one hand and the supply and/or discharge conveyor on the other hand.

34. Method of using a system according to claim 1, comprising bringing a first drive, successively, in different driving positions, for successively driving different object group conveyors.

35. Method according to claim 34, wherein objects are positioned at a distance from each other on at least one said object group conveyor, utilizing in particular a said first drive.

36. Use according to claim 34, wherein objects are disposed centrally on an object group conveyor.

37. A method for arranging and/or storing objects in substantially horizontal stacking patterns, comprising a first sorting step wherein the objects are divided into groups, which groups correspond to the stacking patterns to be formed, while, during a second sorting step, the groups are brought into rows having an order suitable for stacking, while in particular at least several of said objects have different shapes and/or dimensions, and/or masses.

38. A system according to claim 2, wherein
conveying surfaces, or object bearing surfaces, of said object group conveyers extend substantially horizontally;
at least several of said objects have different shapes and/or dimensions, and/or masses;
the system is configured for disposing objects substantially centrally on each object group conveyor, viewed in a transverse direction of the respective object group conveyor;
the first drive is movable between at least a first driving position for driving only the first object group conveyor, and a second driving position for driving only the second object group conveyor;
provided with at least one conveying mechanism for moving a said first drive between the at least first and second driving position, wherein the conveying mechanism is provided with a movable drive carrier, which carrier is provided with said first drive;
the drive carrier is movable to positions located near object group conveyors, in particular to positions located adjacent and/or opposite end parts of these conveyors, for bringing the first drive to said driving positions.

39. A system according to claim 10, provided with at least one supply and/or discharge conveyor for supplying the objects (P) to the object group conveyors and/or discharging them therefrom.

40. A system according to claim 13, wherein
the object manipulator is provided with an endless conveyor, while the latter conveyor extends in particular between opposite sides of the drive carrier;
a said first drive and an object manipulator of a said drive carrier are designed for mutual cooperation for moving objects (P) between a said supply and/or discharge conveyor and said object group conveyors;
a said first drive and an object manipulator of a said drive carrier are designed for positioning objects (P) at a distance from each other on a said supply and/or discharge conveyor.

41. A system according to claim 8,
provided with a first supply/discharge conveyor which extends along first end parts of each of the said object group conveyors, and with a second supply/discharge conveyor which extends along second end parts of each of the said object group conveyors; and
provided with a first conveying mechanism with a first drive carrier for moving a respective first drive between the first end parts of said object group conveyors, and with a second conveying mechanism with a second drive carrier for moving a respective first drive between the second end parts of said object group conveyors.

42. A system according to claim 40, wherein
said conveying mechanism is provided with a guide for guiding the drive carrier between desired positions, while the drive carrier comprises, in particular, a trolley movable along and/or over guide rails;
the conveying mechanism and the drive carrier are configured such that the first drive is movable between said driving positions at a speed of at least 5 m/s, in particular at least 10 m/s;
said conveying mechanism is provided with an endless belt, for instance a geared belt, and with a belt drive for moving the belt, while the first drive is coupled to the endless belt so as to be moved under the influence of the belt drive between said driving positions.
